(19) United States
(12) Patent Application Publication
(10) Pub. No.: US 2026/0111003 A1
(43) Pub. Date: Apr. 23, 2026

(54) AUTOMOTIVE PLUG-IN FOR A COMPUTER DESIGN PROGRAM FOR A COMPUTER NUMERICAL CONTROL (CNC) MACHINE

(71) Applicant: Honda Motor Co., Ltd., Tokyo (JP)

(72) Inventor: William MUDD, Los Angeles, CA (US)

(73) Assignee: Honda Motor Co., Ltd., Tokyo (JP)

(21) Appl. No.: 18/924,329

(22) Filed: Oct. 23, 2024

(51) Int. Cl. G05B 19/4097; G05B 19/409; G05B 19/414

(52) U.S. Cl. CPC G05B 19/4097; G05B 19/409; G05B 19/4145; G05B 2219/31474; G05B 2219/35097; G05B 2219/36076; G05B 2219/45145

(57) ABSTRACT

A method for iterative design using a computer numerical control (CNC) machine for automated changing of a CNC computer design program controlling the CNC machine may install an executable application to the CNC computer design program. The executable application may have a plurality of instructions, when executed by a processor, may cause the processor to display a customer tab on a home screen of the CNC computer design program, wherein the customer tab displays a plurality of icons. The plurality of instructions, when executed by a processor, may cause the processor to synchronize settings of the CNC computer design program to settings on the CNC machine so the settings on the CNC computer design program mirror the settings on the CNC machine when an import icon of the plurality of icons is selected is selected.

### BACKGROUND

Computer numerical control (CNC) machines are machines that may use a computer to provide instructions for movement and/or function of the CNC machine. CNC machines may be used in many different industries to cut, carve, and/or mill a variety of different types of materials to form different products, parts, models, and similar items.

The CNC machine may be controlled by a computer design program. Computer design programs, such as computer-aided design (CAD) programs or computer-aided manufacturing (CAM) programs may be loaded onto the computer coupled to the CNC machine. The computer design programs may be used to control the movement of a tool of the CNC machine around a workpiece across different axes. The tool may cut into the workpiece, revealing the designed programmed shape. These cuts can include sculpting or contouring in addition to complete cuts.

Each object to be formed by the CNC machine may get a custom computer design program which may be loaded into the computer of the CNC machine. The computer design program may use G-codes and M-codes, which may be stored in and executed by a machine control unit (MCU) of the computer. G-codes may use a series of commands or instructions that may tell the CNC machine how to move, position, and operate its various components, such as the cutting tool, spindle, and auxiliary functions. M-code may be used to control miscellaneous CNC machine functions, including starting and stopping specific actions or programs. The G-codes and M-codes may work together to form the desired part and/or component out of the workpiece.

Most CNC machines may be designed for production of the desired part and/or component on a mass level where once the computer design program is uploaded to the computer, minimal changes to the computer design program may be needed. These types of CNC machines may not be designed for an iterative design process such as used in the automotive industry or other design industries. In an automotive iterative design process, a model, which may be formed from clay, may be cut, and/or milled, reviewed, and then changed back to a starting point and then cut, and/or milled, in a different manner. This process may continue over multiple iterations. This iterative design process may require reprogramming of the computer design program each time changes are being made which may be time consuming. Therefore, it may be desirable to provide a plug-in for CNC computer design programs. The plug-in may be designed to allow for customized commands geared towards a specific industry. The plug-in may be designed to allow for customized commands geared towards the automotive industry to boost the production of precision parts with iterative design in a more expeditious manner.

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, a method for iterative design using a computer numerical control (CNC) machine for automated changing of a CNC computer design program controlling the CNC machine is provided. The method may install an executable application to the CNC computer design program, the executable application comprising a plurality of instructions which, when executed by a processor, may cause the processor to display a customer tab on a home screen of the CNC computer design program, wherein the customer tab may displays a plurality of icons. The plurality of instructions which, when executed by a processor, may cause the processor to synchronize settings of the CNC computer design program to settings on the CNC machine so the settings on the CNC computer design program mirror the settings on the CNC machine when an import icon of the plurality of icons is selected.

According to another embodiment of the disclosure, to an embodiment of the disclosure, a non-transitory computer readable medium comprising a plurality of instructions is disclosed. The plurality of instructions, when executed by a processor, may cause the processor to display a customer tab on a home screen of the CNC computer design program, wherein the customer tab displays a plurality of icons for an automotive iterative design process. The plurality of instructions, when executed by a processor, may cause the processor to synchronize settings of the CNC computer design program to settings on the CNC machine so the settings on the CNC computer design program mirror the settings on the CNC machine when an import icon of the plurality of icons is selected. The plurality of instructions, when executed by a processor, may cause the processor to adjust one of a plurality of geometrical components of an automotive workpiece being formed by the CNC machine when one of a plurality of geometry icons of the plurality of icons is selected. The plurality of instructions, when executed by a processor, may cause the processor to shade different curves on the automotive workpiece being formed by the CNC machine different user selected colors on a display, wherein each color assigned is based on a curve radius when a shading icon of the plurality of icons is selected. The plurality of instructions, when executed by a processor, may cause the processor to update a moveable limit setting on the CNC computer design program to a current movable limit setting on the CNC machine when a refresh icon of the plurality of icons is selected. The plurality of instructions, when executed by a processor, may cause the processor to display a user drawn box on the display to visually show movable limits of the CNC machine when a draw icon of the plurality of icons is selected and to remove the user drawn box when a hide icon of the plurality of icons is selected. The plurality of instructions, when executed by a processor, may cause the processor to make user selected surfaces of the automotive workpiece being formed by the CNC machine shown on the display invisible when an invisible icon of the plurality of icons is selected, and to make visible the user selected surfaces that were invisible when an unblank icon of the plurality of icons is selected. The plurality of instructions, when executed by a processor, may cause the processor to adjust a first point and a last point of any selected tool path when an adjust icon of the plurality of icons is selected.

According to an embodiment of the disclosure, a method for iterative design using a computer numerical control (CNC) machine for automated changing of a CNC computer design program controlling the CNC machine is disclosed. The method may be implemented using a control system including a processor communicatively coupled to a memory device. The method may display a customer tab on a home screen of the CNC computer design program. The customer tab may displays a plurality of icons, wherein selecting corresponding icons of the plurality of icons may synchronize settings on the CNC computer design program to settings on the CNC machine, generate a new toolpath, edit geometric settings of a workpiece, shade curves of the workpiece different colors based on curve radiuses, display and hide selected surfaces of the workpiece; and adjust a first point and a last point of a selected tool path.

### BRIEF DESCRIPTION OF THE DRAWINGS

FIG. 1 is a block diagram of a computer system embodying an exemplary computer program plug-in, in accordance with an embodiment of the disclosure;

FIG. 2 is an exemplary screen shot of a CNC machine design program having the computer program plug-in, in accordance with an embodiment of the disclosure;

FIG. 3 is an exemplary screen shot of the CNC machine design program having the computer program plug-in, in accordance with an embodiment of the disclosure;

FIG. 4 is an exemplary screen shot of the CNC machine design program having the computer program plug-in, in accordance with an embodiment of the disclosure;

FIG. 5 is an exemplary screen shot of the CNC machine design program having the computer program plug-in, in accordance with an embodiment of the disclosure; and

FIG. 6 is an exemplary screen shot of the CNC machine design program having the computer program plug-in, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The present disclosure provides a plug-in for a computer controlling a CNC machine. The plug-in may provide custom tab and a plug-in widow that may allow for the generation of toolpaths specifically designed for the automotive industry. The tabs may offer various features related to generating toolpaths, including importing them from machines, geometry, toolpath editing, shading, color surfaces, output, as well as other features. The plug-in may boost production of precision parts with iterative design in the automotive industry.

Reference will now be made in detail to specific aspects or features, examples of which are illustrated in the accompanying drawings. Wherever possible, corresponding, or similar reference numbers will be used throughout the drawings to refer to the same or corresponding parts.

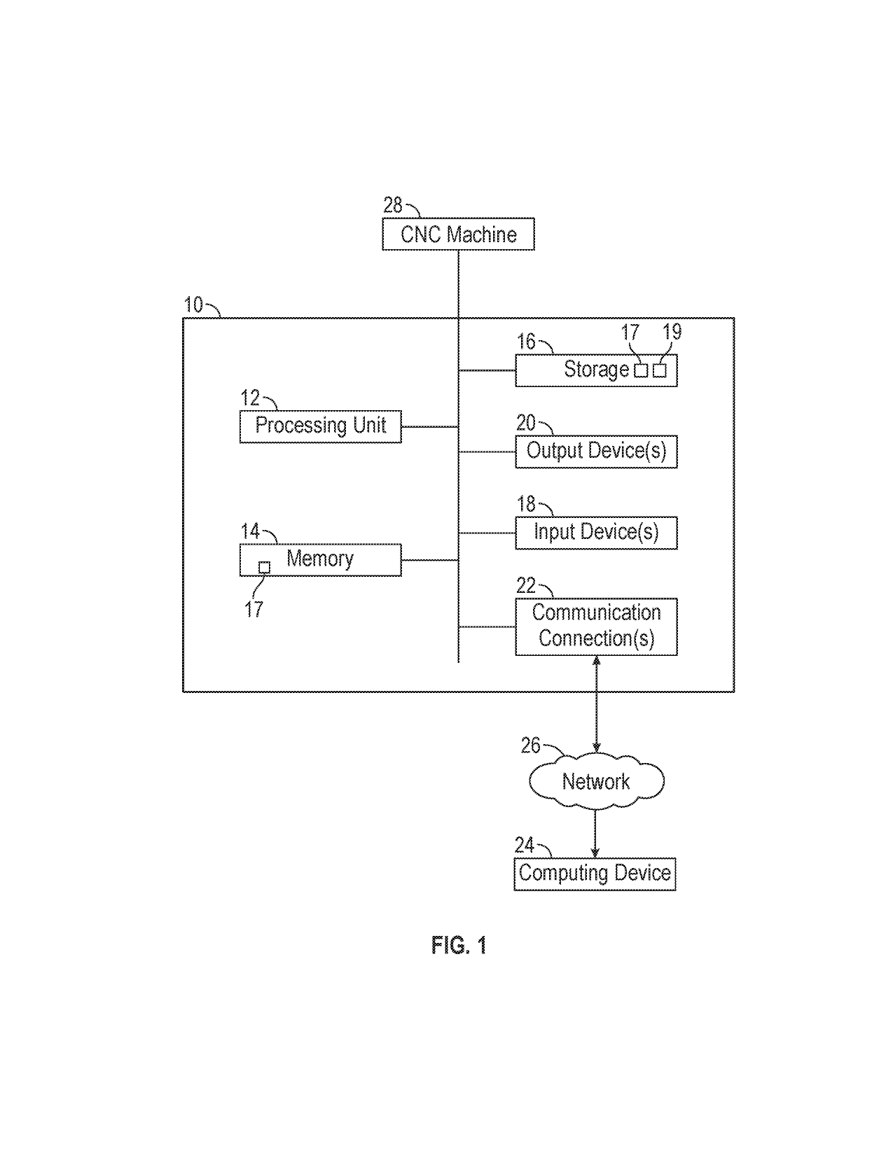

Referring to FIG. 1, a computing device 10 may be shown. The computing device may be used to control the operation of a CNC machine 28. The computing device 10 may be loaded with a plug-in 17 that may add functionality to an existing CNC computer design program 19 loaded therein. In accordance with an embodiment, the computing device 10 may include at least one processing unit 12 and memory 14. Depending on the type of computing device 10, the memory 14 may be volatile, such as RAM, non-volatile, such as ROM, flash memory, etc., or a combination of the two.

The computing device 10 may include additional features or functionality. For example, the computing device 10 may include additional storage such as removable storage or non-removable storage, including, but not limited to, magnetic storage, optical storage, etc. Such additional storage may be illustrated in FIG. 1 by storage 16. In one embodiment, computer readable instructions to implement one aspect of the plug-in 17 may be stored in the storage 16. The storage 16 may store other computer readable instructions to implement an operating system, an application program, such as the CNC computer design program 19, as well as programs. Computer readable instructions may be loaded in the memory 14 for execution by the processing unit 12.

The computing device 10 may include input device(s) 18 such as a keyboard, a mouse, a pen, a voice input device, a touch input device, infrared cameras, video input devices, or any other type of input device. Output device(s) 20 such as one or more displays, speakers, printers, or any other type of output device may be included with the computing device 10. Input device(s) 18 and output device(s) 20 may be connected to the computing device 10 via a wired connection, wireless connection, or any combination thereof. In one embodiment, an input device or an output device from another computing device may be used as input device(s) 18 or output device(s) 20 for the computing device 10. The computing device 10 may include communication connection(s) 22 to facilitate communications with one or more other computing devices 24, such as through a network 26.

The network 26 may be a wired connection or a wireless connection. Examples of the communication network 26 may include, but may not be limited to, the Internet, a cloud network, a Cellular or Wireless Mobile Network (such as a Long-Term Evolution and 5G New Radio), a Wi-Fi network, a PAN, a Local Area Network (LAN), or a Metropolitan Area Network (MAN). The other computing devices 24 may be configured to connect to the network 26 in accordance with various wired communication protocols and wireless communication protocols. Examples of the wire and wireless communication protocols may include, but are not limited to, at least one of a TCP/IP, UDP, HTTP, FTP, Zig Bee, EDGE, IEEE 802.11, Li-Fi, IEEE 802.16, IEEE 802.11s, IEEE 802.11g, multi-hop communication, wireless AP, D2D communication, cellular communication protocols, and BT communication protocols.

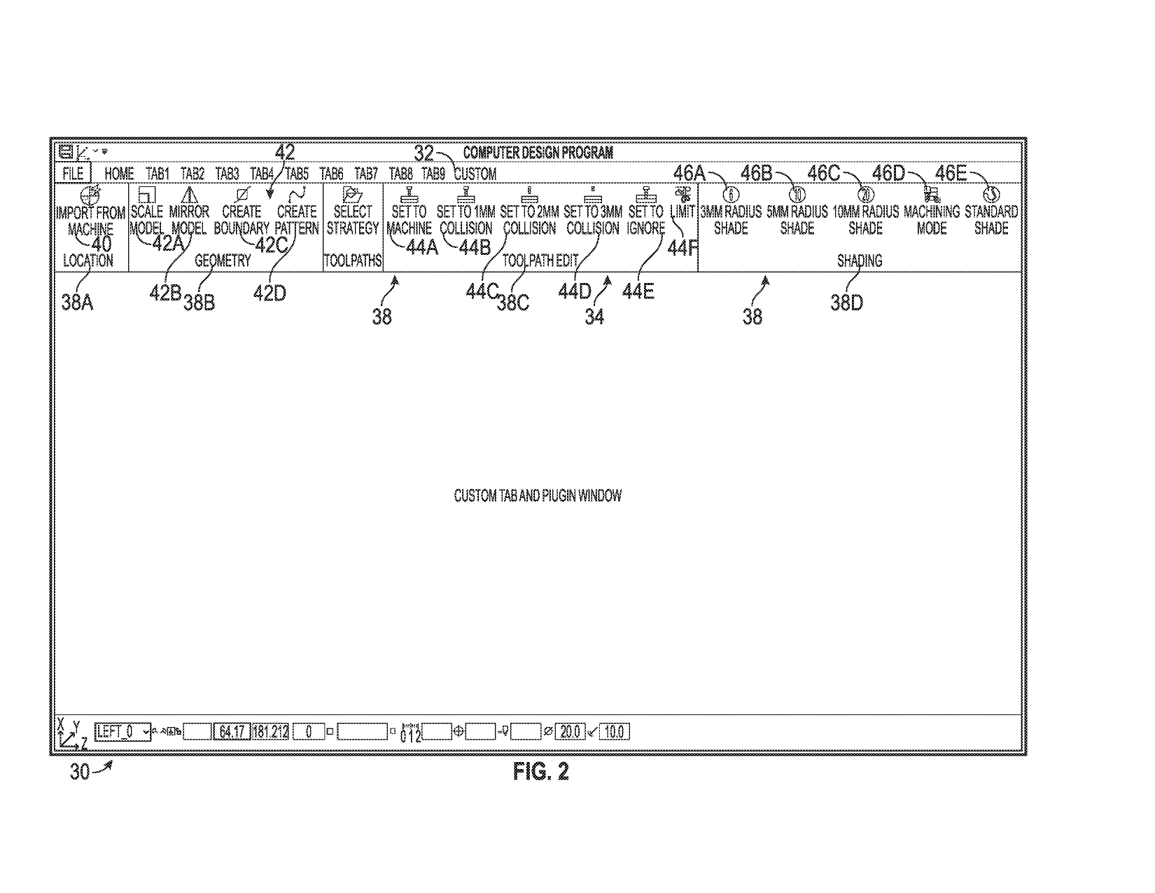

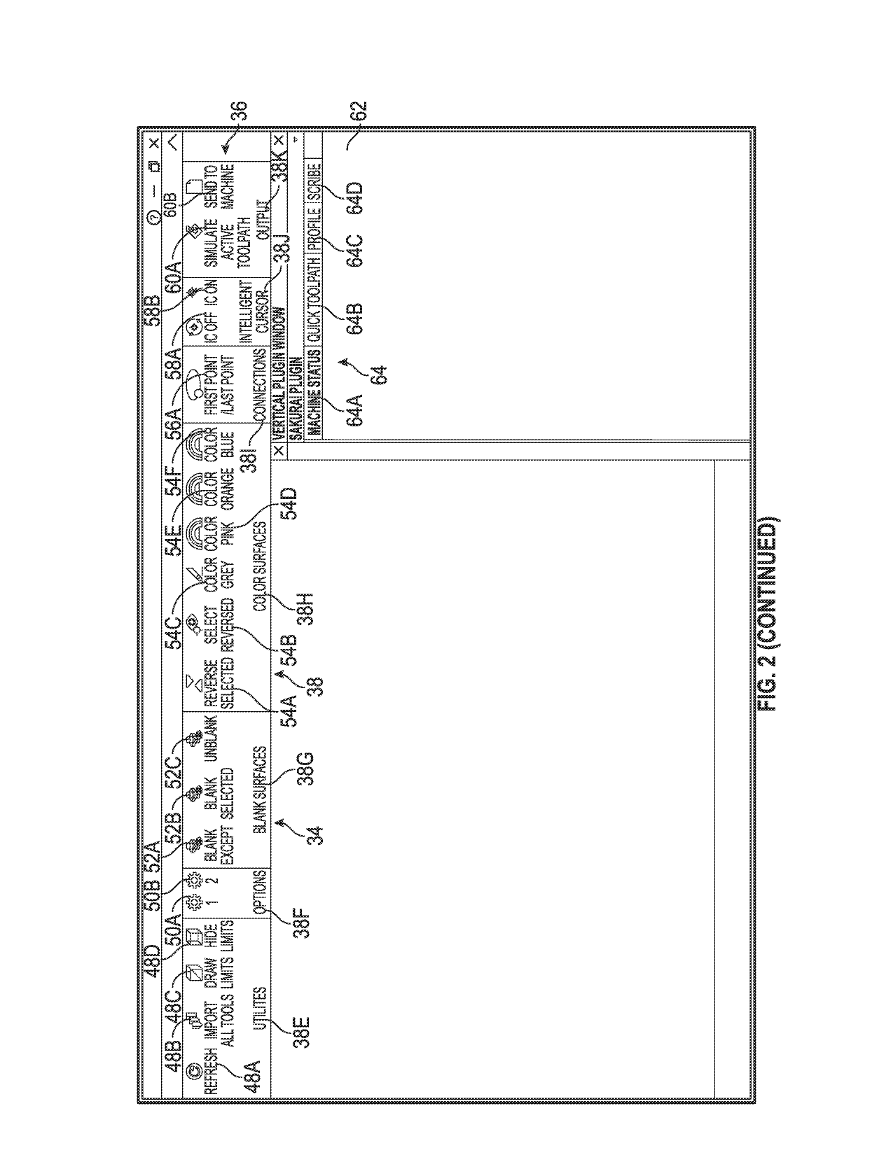

As disclosed above, when the plug-in 17 is added to an existing CNC computer design program 19, the plug-in 17 may add additional functionality to the CNC computer design program 19. Referring to FIG. 2, an exemplary home screen 30 of the computing device 10 (FIG. 1) may be shown. The home screen 30 may be a home screen of the CNC computer design program 19 after the plug-in 17 has been installed. The CNC computer design program 19 may be for a power milling machine.

The plug-in 17 may add a customer tab 32 to the home screen 30. The customer tab 32 may provide a plurality of new commands and/or options 34 that may not be currently available on an existing CNC computer design program home screen. These commands and/or options 34 may be industry specific. In accordance with an embodiment, customer tab 32 may provide commands and/or options 34 for the automotive industry to boost the production of precision parts with iterative design in an expedited manner. For example, these commands and/or options 34 may relate to generating toolpaths, including importing them from machines, geometry, toolpath editing, shading, color surfaces, output, and similar milling features as may be described below.

Selecting the customer tab 32 may display the plurality of new commands and/or options 34. The customer tab 32 may be selected using an input device 18 of the computing device 10. These commands/options 34 may be displayed in a ribbon area 36 of the home screen 30. The ribbon area 36 may be divided into a plurality of groups 38 wherein each group 38 may house similar functional commands/options 34.

In accordance with an embodiment, the groups 38 may include, but are not limited to: Location 38A, Geometry 38B, Tool path Edits 38C, Shading 38D, Utilities 38E, Options 38F, Blank Surfaces 38G, Color Surfaces 38H, Connections 38I, Intelligent Cursor 38J, and Output 38K.

During operation of the CNC machine 28, it may be possible that the CNC computer design program 19 may become out of sync with the CNC machine 28 even when attached. When the settings on the CNC machine 28 and the CNC computer design program 19 conflict, it may cause the CNC machine 28 to cut and/or mill in an inaccurate manner or may cause the CNC machine 28 not to function properly or not function at all. For example, if the positioning of the CNC machine 28 and the CNC computer design program 19 differ, the CNC machine 28 may cut and or mill the object incorrectly. Thus, it may be important that the setting of the CNC computer design program 19 may be in sync with the setting of the CNC machine 28.

The Location 38A group may have an import from machine icon 40. The import from machine icon 40 may allow a user to import all the current settings of the CNC machine 28 into the CNC computer design program 19 once the import from machine icon 40 is selected. Thus, the CNC computer design program 19 may mirror the current settings of the CNC machine 28. By selecting the import from machine icon 40, the user may be ensured that the setting on the CNC computer design program 19 matches that of the CNC machine 28.

The geometry 38B group may have a plurality of icons 42 that may allow a user to manage the design data in the CNC computer design program 19. Each icon 42 may allow the user to adjust a geometrical component of the object being formed by the CNC machine 28. For example, a scale icon 42A may allow the user to adjust a size of the object being formed by the CNC machine 28. In the automotive industry, clay models of a part and/or vehicle may be formed by milling. If the CNC machine 28 is programmed for a 1/4 (i.e. quarter size) model, selecting the scale icon 42A may allow a user to change the size of the model by entering a new scaling factor. In the example above, if the user wanted to make a full-size model, the user may select the scale icon 42A and change the setting to 4 thereby changing the quarter size setting to a full size. Thus, the user may be able to change the scale of the model without having to change any settings on the CNC machine 28 which may allow production of the model in a faster more efficient manner.

The geometry 38B group may have a mirror icon 42B. In the automotive industry, many designers may work on one side of the clay model when designing the part and/or vehicle. For example, when designing a car bumper, the designer may work on one side, for example the driver’s side, first. The mirror icon 42B may allow a user who is working on only half of an object to replicate the work on an opposing side of the object. This may allow the designer to see what the object being designed may look like from different perspectives as well and allow production of the model in a faster more efficient manner as the designer does not have to manually program the CNC computer design program 19 to fully replicate the design.

The geometry 38B group may have a create boundary icon 42C. The create boundary icon 42C may allow the user to create a constraint boundary. The constraint boundary may enable a user to limit the CNC machine 28 to cut and/or mill specific areas of the object being formed. This may help to increase efficiency and prevent unnecessary machining. Boundaries may be closed curves or a collection of closed curves that restrict the entry or exit of the tool of the CNC machine 28 from the bound area. The create boundary icon 42C may allow designers in the automotive industry to focus on certain bound areas of a vehicle part or model and may prevent the CNC machine 28 from cutting or milling outside this bound area.

The geometry 38B group may have a create a pattern icon 42D. The create a pattern icon 42D may be used to form customizable patterns. It may allow the user to form the patterns on the object being designed and to repeat the pattern over a desired boundary area. For example, if the object being designed by the CNC machine 28 is a car grill, the pattern icon 42D may be used to form different patterns to visually see what the car grill may look like. The user may form the pattern on one area of the grill and then repeated the pattern on the entire grill if desired without having to manually program the CNC computer design program 19.

The tool path edits 38C group may have icons 44A-44F which manage how each surface of the object being designed is treated by the CNC computer design program 19. It may be used to set safety tolerances for machining surfaces, collision surfaces and ignore surfaces on the object being designed by the CNC machine 28. These tolerances may be set to those of the CNC machine 28, different predefined tolerances, or one selected by the user.

The shading 38D group may have icons 46A-46E. The icons 46A-46Emay allow the user to obtain real world design information in a visual way. The icons 46A-46E may allow the user to shade different curves on the object in different colors. The colors may be based on the dimensions of the curve. In one embodiment, the icons 46A-46C may be used to shade the different curves on the object based on the radius of the curves on the object. For example, if the object being designed by the CNC machine 28 is a car bumper, the size of a radius on the car bumper may be shade red if the radius is one dimension or may shade green if the radius is another dimension. The different shadings may allow the user to visually see the different appearances of the curve sizes on the bumper.

The utilities 38E group may allow the user to see and set the movable limits of the CNC machine 28. The utilities 38E group may have a refresh icon 48A, an import tools icon 48B, a draw limits icon 48C, and a hide limits icon 48D. The refresh icon 48A may be used to make sure that the current movable limits set on the CNC machine 28 are updated on the CNC computer design program 19. The import tools icon 48B may be used to allow a user to import data from another project into the CNC computer design program. The draw limits icon 48C may be used to allow a user to draw a box on the display 45 (FIG. 1) to visually show the movable limits of the CNC machine 28. The hide limits icon 48C may allow a user to remove the box on the display 45 showing the movable limits of the CNC machine 28.

The options 38F group may have icons 50A and 50B. The icon 50A may allow the CNC computer design program 19 to work with different CNC machines 28. The icon 50 may allow the user to set the CNC computer design program 19 for a specific CNC machine 28. The icon 50B may allow for a simulation function on the CNC computer design program 19. For most CNC computer design programs 19 to function, the computing device 10 storing the CNC computer design program 19 may need to be attached to the CNC machine 28. This may cause a person who would like to train on the CNC computer design program 19 to have to do their training on the CNC machine 28. The icon 50B may provide a simulation function that may allow a person to train on a computing device 10 having the CNC computer design program 19 at their desk without needing the computing device 10 to be attached to the CNC machine 28.

The blank surfaces 38G group may be used to control a visibility of a surface of an object. The blank surfaces 38G group may have icons 52A-52C. The icons 52A-52C may allow a user of the CNC computer design program 19 to make a surface of the object shown on the display 45 visible or invisible. For example, if the object being designed by the CNC machine 28 is a model of a car, the user may use the blank except icon 52A to make all surface to become invisible except the surface selected. Since the car model may have multiple different surfaces, selecting the blank except icon 52A may allow the user to get a better visual indication of the surface appearance selected without the other surfaces of the vehicle obstructing the view. For example, in the car model example, the user may just want to view the exterior of a front door panel. By selecting the blank except icon 52A and selecting the exterior of the front door panel, the exterior of the front door panel may remain visible while all other surfaces of the car model may become invisible. After viewing the exterior of the front door panel, the user may select the unblank icon 52B and all the surfaces that were invisible may be shown again.

In another situation, the use may want to select certain surfaces to make invisible. In this case, the user may use the blank selected icon 52C to make invisible selected surfaces of the object. Thus, in the same car model example above, the user may want to view the side profile of the hood of the car model. The user may use the blank selected icon 52C to make a driver side front panel invisible to get a better visual perspective of the driver side profile view of the hood unobstructed by the driver side front panel. Selecting the unblank icon 52B may cause the surfaces that were choosen to be invisible to be shown again.

The color surfaces 38H group may allow the user to set the color of a surface of the object. The color surfaces 38H group may have icons 54A-52F. The icons 54A-52F may allow the user to set a color of a surface. By using the icons 54A-52F, the user may assign different colors to different surfaces that may be exposed by a milling operation of the CNC machine 28 and to change the color selected to another color of desired. The icons 54A-52F may allow the user to group surfaces according to the color assigned to the different surfaces.

The connections group 38I may have an icon 56A. Selecting the icon 56A may allow the user to adjust a first point and a last point of any tool path depending on the position of the CNC machine 28. In some situations, the CNC machine 28 may not be able to reach a desired starting and/or stopping point of a toolpath, by selecting the icon 56A, the user may adjust the first point and/or the last point of any tool path to allow the CNC machine 28 to reach the desired points of the tool path.

The intelligent cursor group 38J may have icons 58A-58B. The icons 58A-58B may allow the user to activate or deactivate an intelligent cursor on the CNC computer design program 19. When the intelligent cursor is activated, the cursor of the CNC computer design program 19 may snap on a desired surface. Snapping may allow the cursor to be positioned in alignment with grid lines, guide lines or another object, by causing the cursor to automatically jump to an exact position when the user moves to the proximity of the desired location. If the intelligent cursor is deactivated, the cursor of the CNC computer design program may freely move around the surface.

The output group 38K may have icons 60A-60B. The icon 60A may allow the user to simulate a toolpath within the CNC computer design program 19. The simulation may be done in virtue reality within CNC computer design program 19. The simulation may be done for safety reasons to see if there may be any collision issues with the toolpath. If the simulation indicates that there may not be any collision issues and/or other safety issues, the icon 60B may be selected to send the toolpath to the CNC machine 28.

The plug-in 17 may add a window 62. The window 62 may offer a plurality of tabs 64. The tabs 64 may add additional functionality to the CNC computer design program 19. In FIG. 2, four different tabs 64A-64D may be shown. These tabs 64A-64D may include: machine status tab 64A, quick toolpath tab 64B, profile tab 64C, and a scribe tab 64D.

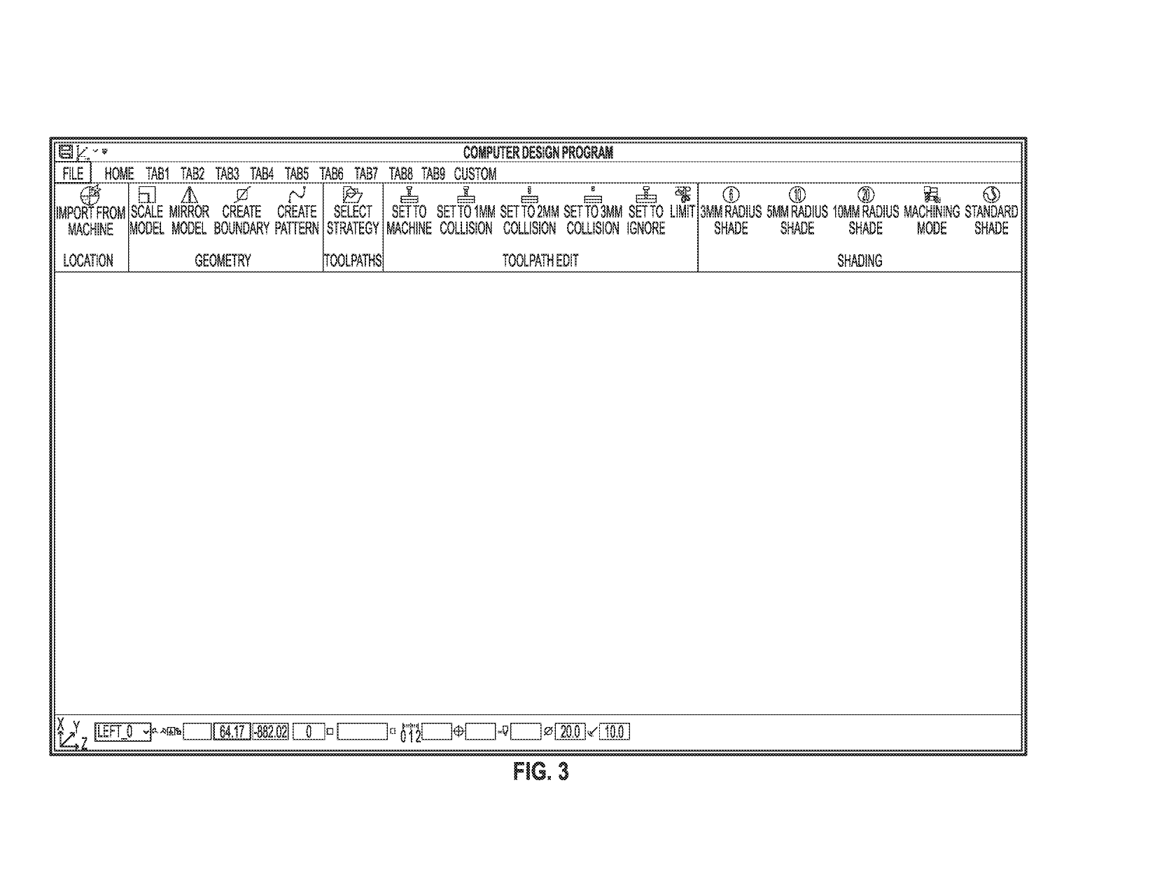

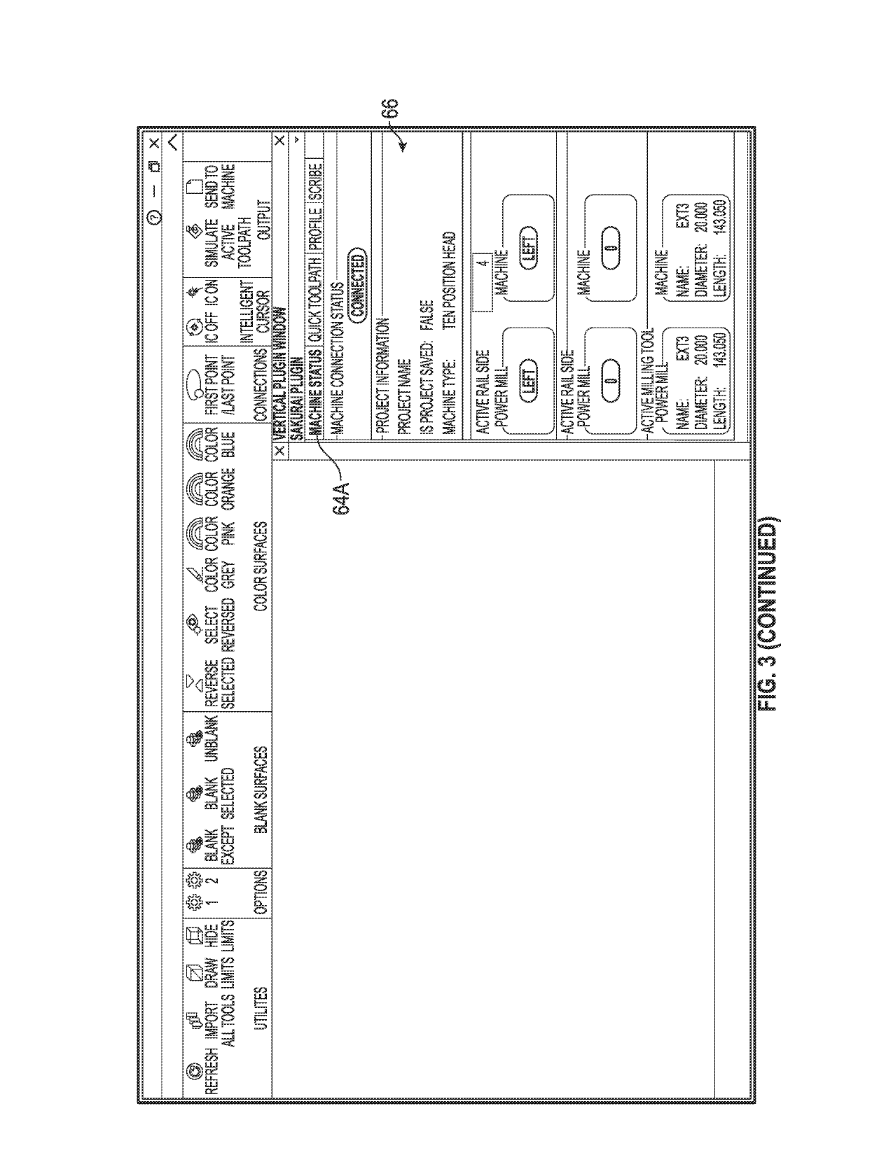

Referring to FIG. 3, the machine status tab 64A may display the current settings of the CNC machine 28 and the CNC computer design program 19. This may allow the user to see which settings between the CNC machine 28 and the CNC computer design program may be the same and which settings may be different and to adjust these setting if needed.

In accordance with an embodiment, the machine status tab 64A may display a window 66. The window 66 may display different settings of the CNC machine 28 and the CNC computer design program 19. As may be shown in FIG. 3, the window 66 may show whether the CNC computer design program is connected to the CNC machine 28, as well as the active settings of the rail, milling tool, head position and other settings of the CNC machine 28 and the CNC computer design program 19. When the settings on the CNC machine 28 and the CNC computer design program 19 conflict, it may cause the CNC machine 28 to cut and/or mill in an inaccurate manner or may cause the CNC machine 28 not to run at all. Using the window 66, the user may adjust conflicting settings between the CNC machine 28 and the CNC computer design program 19. The above are given as examples and other information of the CNC machine 28 and the CNC computer design program 19 may be displayed than those listed above.

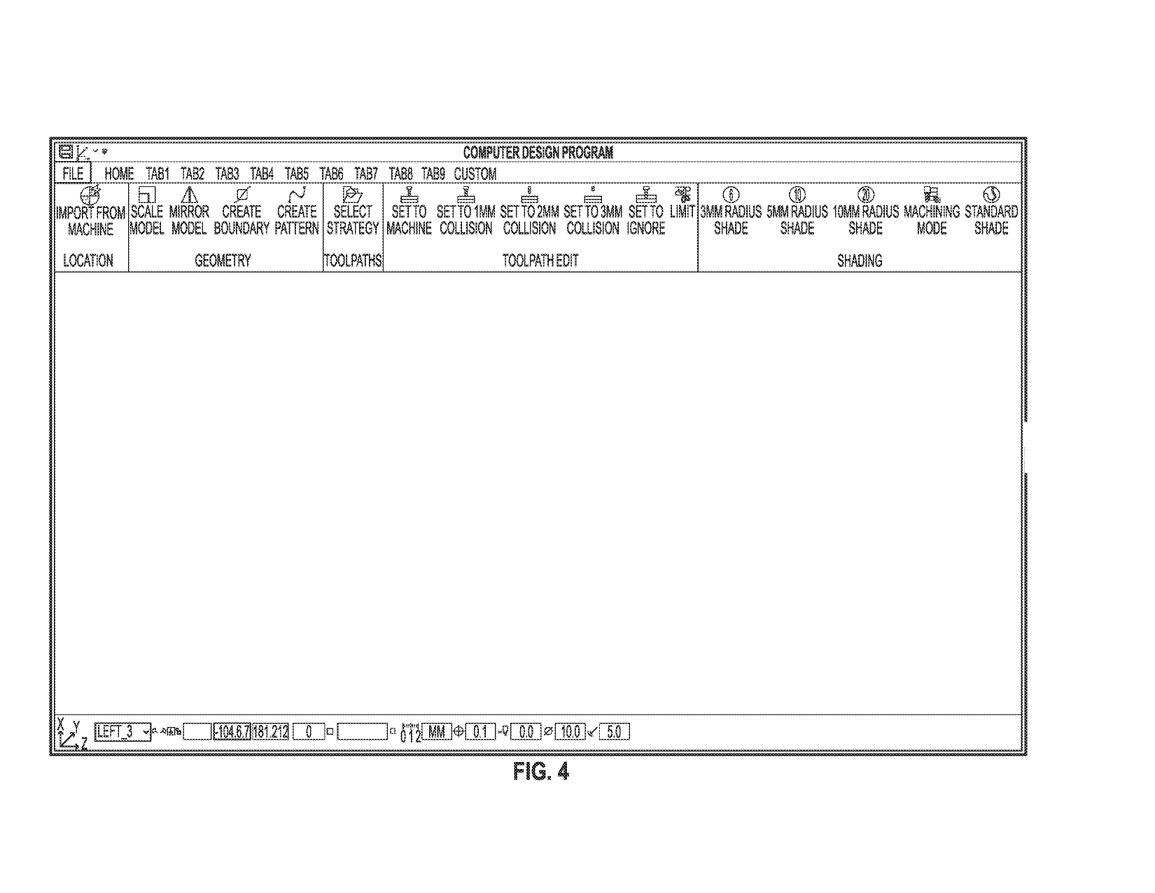

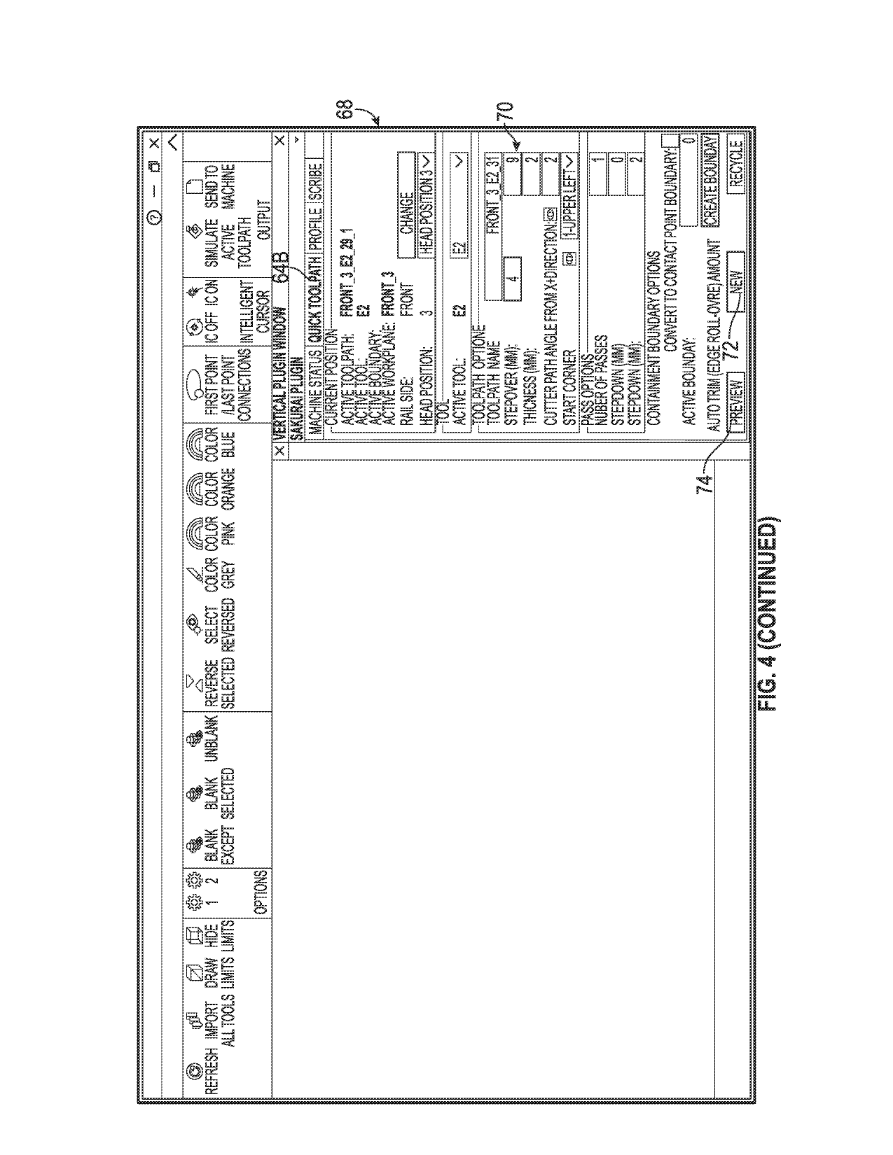

Referring to FIG. 4, the quick toolpath tab 64B may be used to form a new toolpath for the CNC machine 28. The quick toolpath tab 64B may display a window 68. The window 68 may display a plurality of fillable fields 70. The user may enter the desired information in the fillable fields 70 to form the new toolpath. For example, the user may enter tool path information such as stepover information relating to the distance between two adjacent toolpath cuts in the X and Y axes, a thickness and/or depth of a cut being made by the tool of the CNC machine 28, an angle of a path of a tool of the CNC machine 28, and a location and/or corner of a starting point of the toolpath. The fillable fields 70 may allow the user to enter information related to pass options. For example, the user may enter pass information such as the number of passes the tool of the CNC machine 28 should make, a distance the tool of the CNC machine 28 engages a workpiece, and a thickness of the material being milled each pass. The above are given as examples and other information may be entered than those listed above. While the window 68 may display a plurality of fillable fields 70, information does not need to be entered and/or changed in all the fillable fields 70. Once the desired information has been added into the desired fillable fields 70, the user may select the icon 72 to generate the new toolpath. The window 68 may have a preview icon 74. When selected, the preview icon 74 may display to simulated version of the toolpath generated.

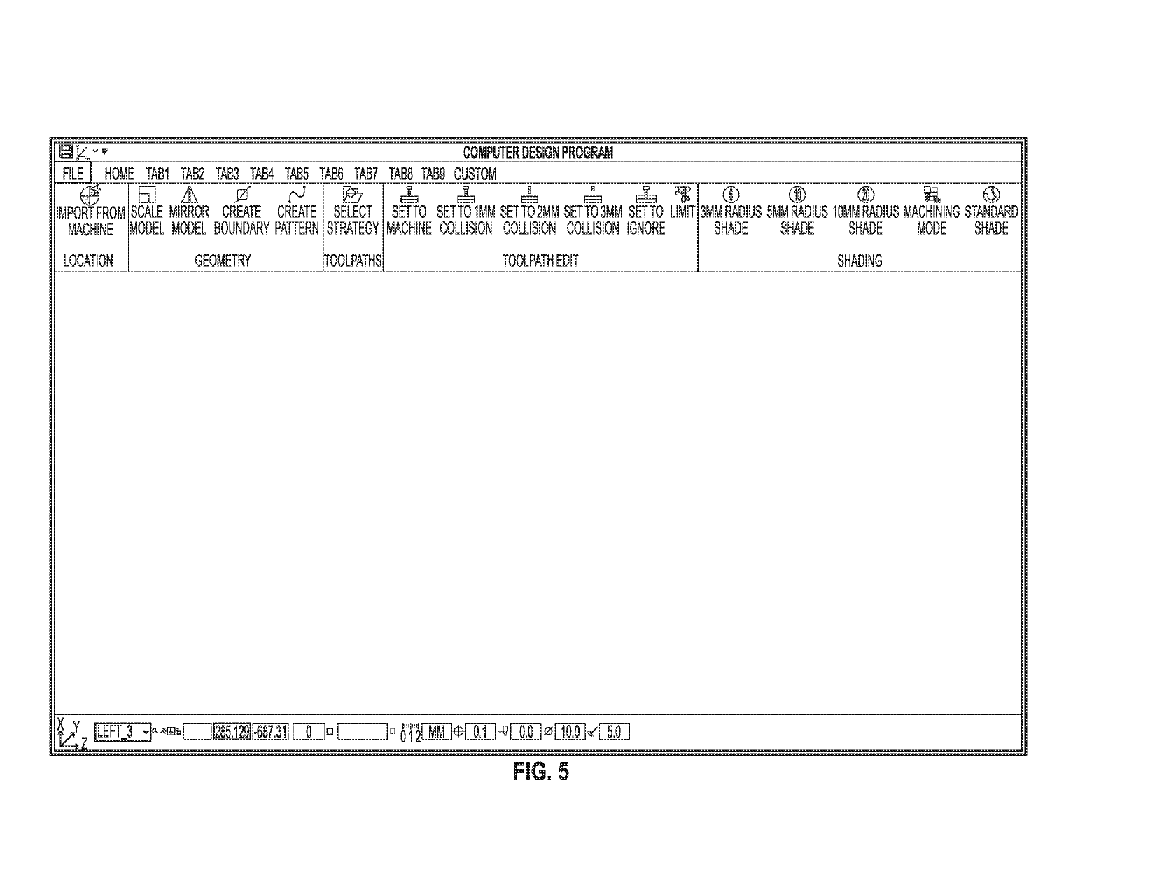

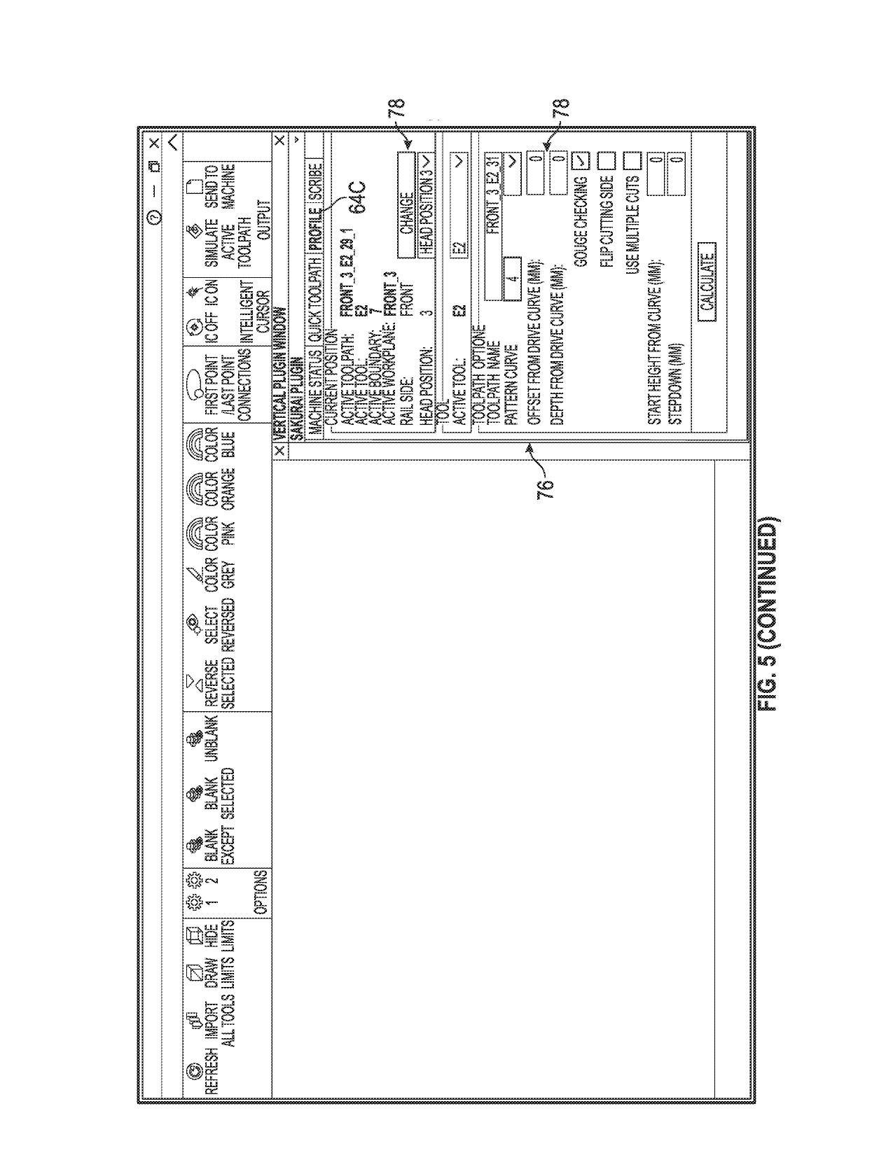

Referring to FIG. 5, the profile tab 64C may allow the user to form a specific type of toolpath, a profile toolpath without having to manually reprogram the the CNC computer design program 19. A profile toolpath may cut and/or mill along a line or curve. The profile tab 64C may have a window 76. The window 76 may display a plurality of fillable fields 78. The user may enter the desired information in the fillable fields 78 to form the new profile toolpath. For example, the user may enter information relating to an offset from the line or curve of the profile toolpath, a thickness and/or depth of a cut being made by the tool of the CNC machine 28, a depth of a cut being made by a tool of the CNC machine 28, and similar related information. The above are given as examples and other information may be entered than those listed above to define the profile toolpath.

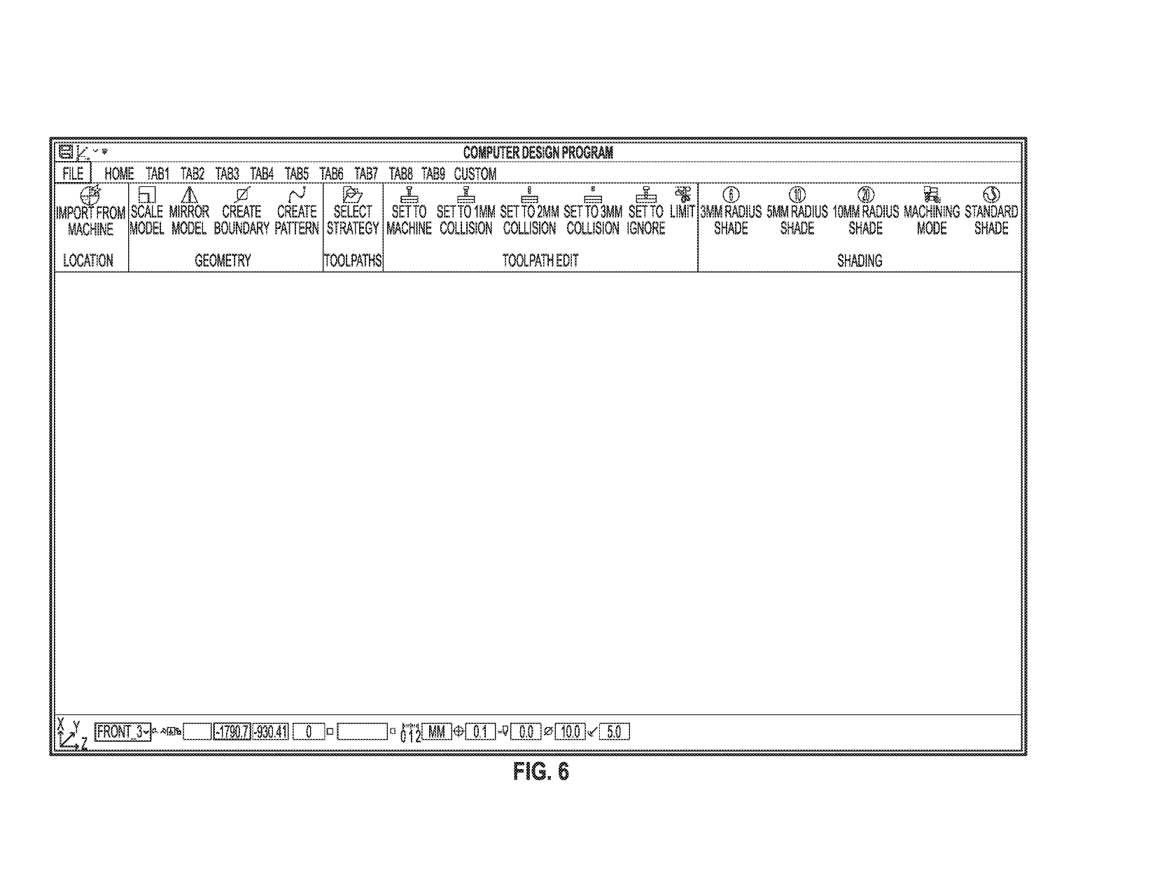

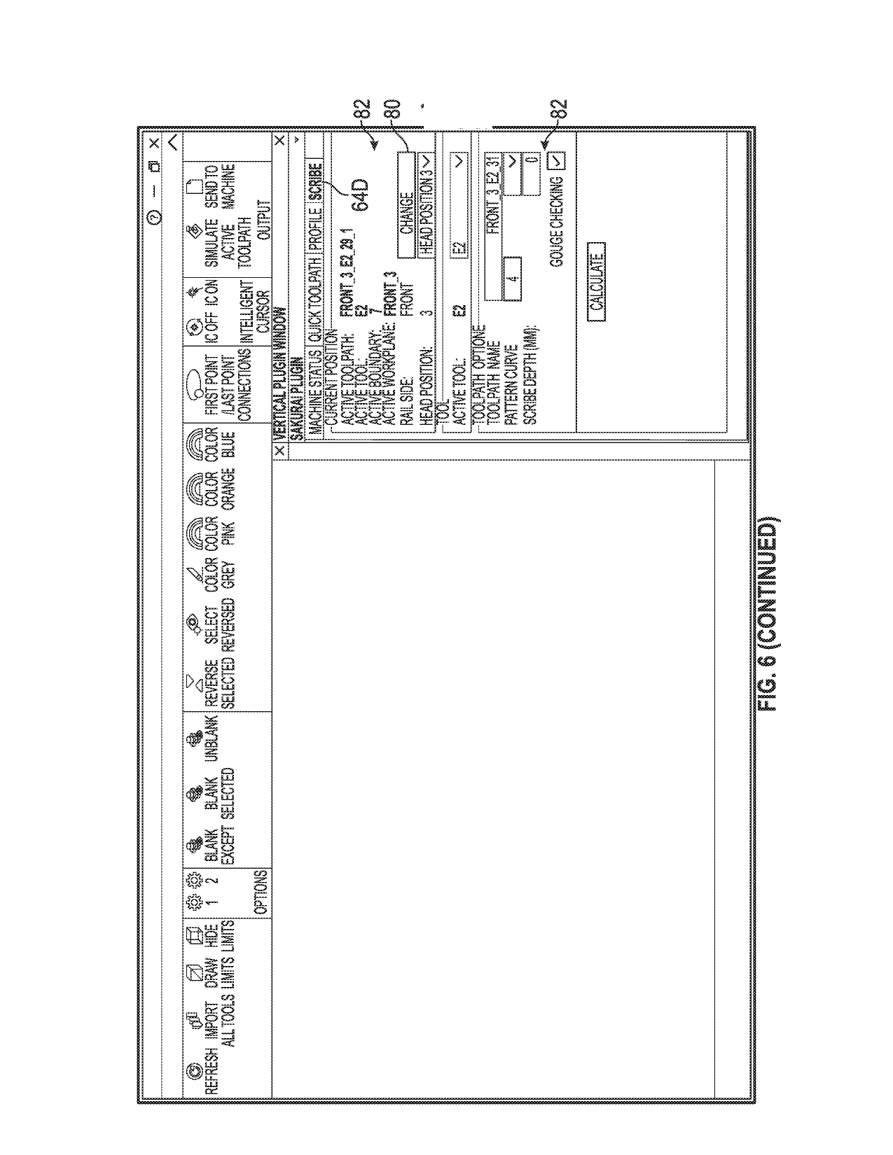

Referring to FIG. 6, the scribe tab 64D may allow the user to form a specific type of toolpath, a scribe toolpath without having to manually reprogram the the CNC computer design program 19. A scribe toolpath may be used to form mark or engrave a surface of the material of the product without cutting through the material. The scribe tab 64D may have a window 80. The window 80 may display a plurality of fillable fields 82. The user may enter the desired information in the fillable fields 82 to form the scribe toolpath. For example, the user may enter information relating to a pattern curve, scribe depth, and similar information relating to a scribe toolpath. The above are given as examples and other information may be entered than those listed above to define the scribe toolpath.

The plug-in 17, which is added to an existing CNC computer design program 19, generates a custom tab and plug-in window 62 specifically designed for the automotive industry. The customer tab 32 and window 62 may boost the production of precision parts with iterative design. The custom tab 32 offers various features related to generating toolpaths, including importing the toolpaths from other machines, geometry, toolpath editing, shading, color surfaces, output, and similar features. The window 62 offers four different tabs, namely: machine status tab (connection or disconnection status, active rail slide - which machine or tool is active), quick toolpath tab (active toolpath, tool, boundary, workplane), profile tab (profile is a different kind of toolpath used for cutting the perimeter instead of inside/body side), and a scribe tab (selecting desired scribing or engraving depth using an etching tool). The plug-in 17 may boost production of precision parts with iterative design in the automotive industry.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not to be limited to the particular embodiment disclosed, but that the present disclosure will include all embodiments that fall within the scope of the appended claims.

1. A method for iterative design using a computer numerical control (CNC) machine for automated changing of a CNC computer design program controlling the CNC machine comprising:
installing an executable application to the CNC computer design program, the executable application comprising a plurality of instructions which, when executed by a processor, causes the processor to:
display a customer tab on a home screen of the CNC computer design program, wherein the customer tab displays a plurality of icons; and
synchronizing settings of the CNC computer design program to settings on the CNC machine so the settings on the CNC computer design program mirror the settings on the CNC machine when an import icon of the plurality of icons is selected.

2. The method of claim 1, wherein the plurality of instructions, when executed by a processor, causes the processor to adjust one of a plurality of geometrical components of a workpiece being formed by the CNC machine when one of a plurality of geometric icons of the plurality of icons is selected.

3. The method of claim 1, wherein the plurality of instructions which, when executed by a processor, causes the processor to:
adjust a scale size of a workpiece being formed by the CNC machine when a scale icon of the plurality of icons is selected;
mirror a design formed on one half of the workpiece to a second half of the workpiece when a mirror icon of the plurality of icons is selected;
create a constraint boundary around a used selected area of the workpiece to limit an area where the CNC machine cuts the workpiece when a constraint icon of the plurality of icons is selected; and
create a user defined pattern to be formed on the workpiece when a pattern icon of the plurality of icons is selected.

4. The method of claim 1, wherein the plurality of instructions, when executed by a processor, causes the processor to set safety tolerances for machining surfaces, collision surfaces and ignore surfaces on a workpiece being formed by the CNC machine, wherein the safety tolerances are user selected and are one of: tolerances of the CNC machine, predefined tolerances, or user selected tolerances.

5. The method of claim 1, wherein the plurality of instructions, when executed by a processor, causes the processor to shade different curves on a workpiece being formed by the CNC machine different user selected colors, wherein each color assigned is based on a curve radius when a shading icon of the plurality of icons is selected.

6. The method of claim 1, wherein the plurality of instructions, when executed by a processor, causes the processor to update a moveable limit setting on the CNC computer design program to a current movable limit setting on the CNC machine when a refresh icon of the plurality of icons is selected.

7. The method of claim 1, wherein the plurality of instructions, when executed by a processor, causes the processor to import data from another design project into the CNC computer design program when an import icon of the plurality of icons is selected.

8. The method of claim 1, wherein the plurality of instructions, when executed by a processor, causes the processor to display a user drawn box to visually show movable limits of the CNC machine on a display when a draw icon of the plurality of icons is selected and to remove the user drawn box from the display when a hide icon of the plurality of icons is selected.

9. The method of claim 1, wherein the plurality of instructions, when executed by a processor, causes the processor to set the CNC computer design program to a specific CNC machine when an option icon of the plurality of icons is selected.

10. The method of claim 1, wherein the plurality of instructions, when executed by a processor, causes the processor to make user selected surfaces of a workpiece being formed by the CNC machine shown on a display invisible when an invisible icon of the plurality of icons is selected, and to make visible on the display the user selected surfaces that were invisible when an unblank icon of the plurality of icons is selected.

11. The method of claim 1, wherein the plurality of instructions, when executed by a processor, causes the processor to make all surface of a workpiece being formed by the CNC machine shown on a display invisible except for a surface selected by a user when an invisible icon of the plurality of icons is selected and to cause all invisible surfaces to become visible on the display when an unblank icon of the plurality of icons is selected.

12. The method of claim 1, wherein the plurality of instructions, when executed by a processor, causes the processor to assign different user selected colors to different surfaces that are exposed by a milling operation of the CNC machine and shown on a display and to group surfaces having a same color together on the display when a color icon of the plurality of icons is selected.

13. The method of claim 1, wherein the plurality of instructions, when executed by a processor, causes the processor to adjust a first point and a last point of a selected tool path when an adjust icon of the plurality of icons is selected.

14. The method of claim 1, wherein the plurality of instructions, when executed by a processor, causes the processor to activate or deactivate an intelligent cursor on the CNC computer design program when an intelligent icon of the plurality of icons is selected and deselected.

15. The method of claim 1, wherein the plurality of instructions, when executed by a processor, causes the processor to simulate a toolpath on a display when a simulate icon of the plurality of icons is selected.

16. The method of claim 1, wherein the plurality of instructions, when executed by a processor, causes the processor to display a window on the home screen, the window having a plurality of tabs, and wherein the widow displays current settings of the CNC machine and the CNC computer design program to see if any settings conflict when a status tab is selected, wherein the window displays fillable fields to form a new toolpath when a toolpath tab is selected.

17. A non-transitory computer readable medium comprising a plurality of instructions which, when executed by a processor, cause the processor to:
display a customer tab on a home screen of the CNC computer design program, wherein the customer tab displays a plurality of icons for an automotive iterative design process;
synchronizing settings of the CNC computer design program to settings on the CNC machine so the settings on the CNC computer design program mirror the settings on the CNC machine when an import icon of the plurality of icons is selected;
adjust one of a plurality of geometrical components of an automotive workpiece being formed by the CNC machine when one of a plurality of geometry icons of the plurality of icons is selected;
shade different curves on the automotive workpiece being formed by the CNC machine different user selected colors on a display, wherein each color assigned is based on a curve radius when a shading icon of the plurality of icons is selected;
update a moveable limit setting on the CNC computer design program to a current movable limit setting on the CNC machine when a refresh icon of the plurality of icons is selected;
display a user drawn box on the display to visually show movable limits of the CNC machine when a draw icon of the plurality of icons is selected and to remove the user drawn box when a hide icon of the plurality of icons is selected;
make user selected surfaces of the automotive workpiece being formed by the CNC machine shown on the display invisible when an invisible icon of the plurality of icons is selected, and to make visible the user selected surfaces that were invisible when an unblank icon of the plurality of icons is selected; and
adjust a first point and a last point of a selected toolpath when an adjust icon of the plurality of icons is selected.

18. The non-transitory computer readable medium of claim 17, wherein the plurality of instructions, when executed by a processor, cause the processor to:
display a window on the home screen, the window having a plurality of tabs, and wherein the widow displays current settings of the CNC machine and the CNC computer design program to see if any settings conflict when a status tab is selected, wherein the window displays fillable fields to form a new toolpath when a toolpath tab is selected.

19. A method for iterative design using a computer numerical control (CNC) machine for automated changing of a CNC computer design program controlling the CNC machine, the method implemented using a control system including a processor communicatively coupled to a memory device, the method comprising:
display a customer tab on a home screen of the CNC computer design program, wherein the customer tab displays a plurality of icons, selecting corresponding icons of the plurality of icons synchronizes settings on the CNC computer design program to settings on the CNC machine, generates a new toolpath, edits geometric settings of a workpiece, shades curves of the workpiece different colors based on curve radiuses, displays and hides selected surfaces of the workpiece; and adjusts a first point and a last point of any selected tool path.

20. The method of claim 19, comprising displaying a window on the home screen, the window having a plurality of tabs, and wherein the widow displays current settings of the CNC machine and the CNC computer design program to see if any settings conflict when a status tab is selected, wherein the window displays fillable fields to form a new toolpath when a toolpath tab is selected.
